(19) United States
(12) Patent Application Publication
(10) Pub. No.: US 2018/0278919 A1
(43) Pub. Date: Sep. 27, 2018

(54) SYSTEM FOR TRACKING SUBJECT MOVING WITHIN SPACE USING STEREO CAMERAS

(71) Applicant: GEOSPATIAL INFORMATION TECHNOLOGY CO., LTD., Seongnam-si, Gyeonggi-do (KR)

(72) Inventors: Jong Hoon LEE, Seoul (KR); In Kyu HWANG, Uiwang-si (KR); Jun Ho CHEON, Seongnam-si (KR)

(21) Appl. No.: 15/323,274

(22) PCT Filed: Dec. 9, 2016
(86) PCT No.: PCT/KR2016/014491

§ 371 Date: Dec. 30, 2016

(30) Foreign Application Priority Data
Dec. 9, 2015 (KR) 10-2015-0174874

(51) Int. Cl. H04N 13/296; H04N 7/18; H04N 13/204; G06K 9/00

(52) U.S. Cl. CPC H04N 13/296; H04N 7/181; G06K 2209/15; G06K 9/00825; H04N 13/204

(57) ABSTRACT

A system for tracking a subject moving within a space using stereo cameras includes stereo cameras installed in different directions, a space data composition unit forming a space map where information about 3D space is shared by matching depth maps generated in photographing areas of the stereo cameras, a subject sensing unit analyzing point clouds or the space map and determining that the subject is present in a photographing area of a stereo camera corresponding to a point, a PTZ camera moving so that a photographing direction is directed toward the subject, and a driving control unit driving the PTZ camera using a first method for setting an initial value and for driving the PTZ camera and/or a second method for setting the photographing zones of the 3D space, presetting the driving values of the PTZ camera, fetching the preset value of the zone, and driving the PTZ camera.

### BACKGROUND OF THE INVENTION

### 1. Technical Field

The present invention relates to a stereo camera in a measuring technology field and, more particularly, to a system for tracking the subject that moves within a space using a plurality of stereo cameras, which forms a logic structure of a digital form for a three-dimensional (3-D) space by combining a PTZ camera and a plurality of stereo cameras, facilitates the tracking of a movement of the subject through the sharing of information about the 3-D space, and enables precise tracking by setting the pan, tilt, and zoom driving values of the PTZ camera based on the 3-D coordinates of the subject.

### 2. Description of Related Art

In general, closed circuit television (CCTV) is disposed at places that require security, such as houses, departments, banks, and exhibition centers, in order to prevent disasters, such as trespassing, robbery and fire, and for rapid processing for the disasters. Furthermore, a lot of CCTV is installed on an underground parking lot in which crimes are frequently generated or roads for parking regulation.

Conventional CCTV has a disadvantage in that it can photograph only a specific portion. In order to solve such a disadvantage, efforts are made to configure a plurality of pieces of CCTV or to widen a photographing range using a camera on which a fisheye lens has been mounted as disclosed in Korean Patent No. 1311859. Even in such a case, however, only the photographing range is widened, and the development of a system for continuously tracking a movement of the subject, such as a vehicle or a person, that is, the subject of monitoring, remains in a meager level.

That is, when a movement of the subject is sensed by conventional CCTV, the subject is, photographed by manually or automatically manipulating a high-resolution camera provided separately from the CCTV in order to obtain information (e.g., a face if the subject is a person and a license plate if the subject is a vehicle) about the subject. Information about a 3-D space is not shared because the camera for sensing a movement of the subject and the high-resolution camera for obtaining information about the subject individually operate as described above. As a result, there is a disadvantage in that the retracing of the subject is difficult it the subject continues to move while the subject is tracking.

(Patent Document 1) Korean Patent No. 1311859 (Sep. 17, 2013) “The system and the method for monitoring illegal stopping and parking vehicles using an omnidirectional camera”

### SUMMARY OF THE INVENTION

The present invention has been invented to solve the problems, and an object of the present invention is to provide a plurality of stereo cameras, which forms a logic structure of a digital form for a 3-D space by combining a PTZ camera and a plurality of stereo cameras, facilitates the tracking of a movement of the subject by sharing information about the 3-D space, and enables precise tracking by setting the pan, tilt, and zoom driving values of the PTZ camera based on the 3-D coordinates of the subject.

According to an aspect of the present invention, there is provided a system for tracking the subject that moves within a space using a plurality of stereo cameras, including a plurality of stereo cameras fixed and installed in different directions, space data composition unit configured to form a space map in which information about a 3-D space is shared by matching depth maps generated in photographing areas of the plurality of stereo cameras, the subject sensing unit configured to analyze the point clouds of the space map and to determine that the subject is present in a photographing area of a stereo camera corresponding to a specific point when there is a change in the specific point, a PTZ camera configured to move so that a photographing direction is directed toward the subject by performing panning and tilting and to perform zooming based on the subject, and a driving control unit configured to drive the PTZ camera using any one of a first method for setting an initial value by matching the location of any one point in the photographing range of a stereo camera with an angle of the PTZ camera and for driving the PTZ camera based on a zoom level calculated based on a pan angle and tilt angle for a movement based on the center coordinates of the subject when the subject is sensed and the distance between the subject and the PTZ camera and a second method for setting the photographing zones of the 3-D space, manually presetting the driving values of the PTZ camera so that a photographing direction is directed toward a set photographing zone, fetching the preset value of the zone in which the subject is sensed, and driving the PTZ camera or a combination of the first and the second methods. Four stereo cameras are installed to photograph east, west, south, and north directions, respectively. The four stereo cameras are spaced apart from each other, and each includes a left-eye lens and a right-eye lens having parallel optical axes. The four stereo cameras are installed around the PTZ camera in a form to surround the PTZ camera.

### ADVANTAGEOUS EFFECTS

In accordance with the system for tracking the subject that moves within a space using a plurality of stereo cameras according to an embodiment of the present invention, the subject can be continuously tracked although the subject moves while it is tracking.

Furthermore, the 3-D coordinates of the subject can be extracted using the stereo cameras, and thus the subject can be precisely tracked by setting the pan, tilt, and zoom driving values of the PTZ camera based on the extracted 3-D coordinates.

### BRIEF DESCRIPTION OF DRAWINGS

FIG 1 is a schematic block diagram of a system for tracking the subject that moves within a space using a plurality of stereo cameras according to an embodiment of the present invention.

FIG. 2 is a diagram showing an embodiment of stereo cameras and a PTZ camera included in an embodiment of the present invention.

FIG. 3 is a plan view of the photographing areas of stereo cameras included in an embodiment of the present invention.

FIG. 4 is a diagram showing the photographing areas of FIG. 3 in the form of a 3-D depth map.

FIG. 5 is a diagram showing the 3-D space map in which the plurality of depth maps shown in FIG. 4 has been matched into one, and

FIG. 6 is a diagram illustrating a first method and a second method for driving the PTZ camera, which are included in an embodiment of the present invention.

### DESCRIPTION OF REFERENCE NUMERALS

100: system for tracking the subject that moves within a space using a plurality of stereo cameras

110: stereo camera 120: space data composition unit

130: subject sensing unit 140: driving control unit

150: PTZ camera

### DETAILED DESCRIPTION OF THE INVENTION

According to an aspect of the present invention, there is proposed a system for tracking the subject that moves within a space using a plurality of stereo cameras, including a plurality of stereo cameras fixed and installed in different directions, a space data composition unit configured to form a space map in which information about a 3-D space is shared by matching depth maps generated in photographing areas of the plurality of stereo cameras, the subject sensing unit configured to analyze the point clouds of the space map and to determine that the subject is present in a photographing area of a stereo camera corresponding to a specific point when there is a change in the specific point, a PTZ camera configured to move so that a photographing direction is directed toward the subject by performing panning and tilting and to perform zooming based on the subject, and a driving control unit configured to drive the PTZ camera using any one of a first method for setting an initial value by matching the location of any one point the photographing range of a stereo camera with an angle of the PTZ camera and for driving the PTZ camera based on a zoom level calculated based on a pan angle and tilt angle for a movement based on the center coordinates of the subject when the subject is sensed and the distance between the subject, and the PTZ camera and a second method for setting the photographing zones of the 3-D space, manually presetting the driving values of the PTZ camera so that a photographing direction is directed toward a set photographing zone, fetching the preset value of the zone in which the subject is sensed, and driving the PTZ camera or a combination of the first and the second methods. Four stereo cameras are installed to photograph east, west, south, and north directions respectively. The four stereo cameras are spaced apart from each other, and each includes a left-eye lens and a right-eye lens having parallel optical axes. The four stereo cameras are installed around the PTZ camera in a form to surround the PTZ camera.

The merits and characteristics of the present invention and a technology for achieving the merits and characteristics thereof will become more apparent from the following embodiments taken in conjunction with the accompanying drawings. However, the present invention is not limited to the disclosed embodiments, but may be implemented in various ways. The embodiments may be provided to complete the disclosure of the present invention and to enable those skilled in the art to understand the range of right of the present invention.

Terms used in the specification are provided to describe the embodiments and are not intended to limit the present invention. In the specification, the singular form, unless specially described otherwise, may include the plural form. Furthermore, elements, steps, and operations used in the specification do not exclude the existence or addition of one or more other elements, steps, and operations.

In the drawings, an element has not been drawn based on an actual scale. For example, the size of some elements in the drawings may have been exaggerated compared to other elements in order to help understanding of the present invention. Furthermore, the same reference numeral denotes the same element through the drawings, and the drawings illustrate a common configuration method for simplicity and clarity purposes. Furthermore, a detailed description of the known characteristics and technologies may have been omitted in order to avoid making the discussion of an embodiment described in the present invention unnecessarily obscure.

Detailed embodiments for implementing the present invention are described in detail below with reference to the accompanying drawings.

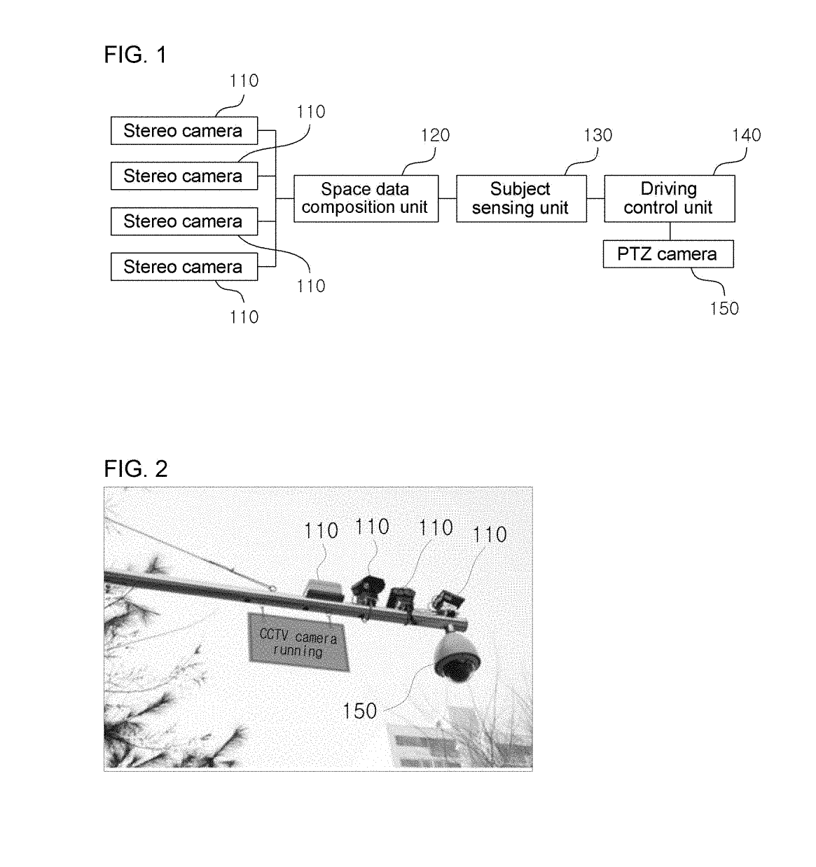

FIG. 1 is a schematic block diagram of a system for tracking the subject that moves within a space using a plurality of stereo cameras according to an embodiment of the present invention. FIG. 2 is a diagram showing an example in which the stereo cameras and a PTZ camera have been installed, which is included in an embodiment of the present invention.

Referring to FIGS. 1 and 2, a system 100 for tracking the subject that moves within a space using a plurality of stereo cameras according to an embodiment of the present invention basically includes stereo cameras 110 a space data composition unit 120, a subject sensing unit 130 a driving control unit 140, and a PTZ camera 150. In this case, physical elements installed outside include the stereo cameras 110 and the PTZ camera 150. The space data composition unit 120, the subject sensing unit 130, and the driving control unit 140 operate based on a PC on which a coded program has been installed.

A plurality of the stereo cameras 110 is configured. The stereo cameras 110 are fixed and installed in different directions and share a 3-D space. That is, four stereo cameras 110 may be installed to photograph respective designated directions, for example, east, west, south, and north roads in the intersection so that a blind spot is not generated in the 3-D space, as shown in FIG. 2. As described above, the number of stereo cameras 110 has only to be installed, to share the 3-D space. The four stereo cameras do not need to be essentially installed at the intersection. In the technology field to which the present invention pertains, it is evident that five or more stereo camera may be installed if a closer photographing range is required.

The four stereo cameras 110 are illustrated, as being configured as shown in FIG. 2. For convenience sake, the four stereo cameras 110 are clockwise referred to as a first stereo camera 110, a second stereo camera 110, a third stereo camera 110, and a fourth stereo camera 110, respectively, based on the stereo camera 110 that photographs the east road.

The first to fourth stereo cameras 110 are spaced apart from each other at a specific interval (i.e., a baseline), and each includes a left-eye lens and a right-eye lens having parallel optical axes. Accordingly, each of the stereo cameras calculates how much pixels are the same points spaced apart from each other in mages captured by the left-eye lens and the right-eye lens, respectively, that is, a parallax according to the left-eye lens and the right-eye lens in a shared image, calculates, a depth value between the stereo camera and the subject, and generates a depth map based on the calculated depth value. In the present embodiment, the number of depth raps generated by the first to fourth stereo cameras 110 may be four because the four stereo cameras 110 are configured. In an embodiment of the present invention, as described above, the depth maps generated according to the photographing areas of the respective stereo cameras 110 are matched up with a single 3-D space. This is performed by the space data composition unit 120 which receives photographing data from the stereo cameras 110.

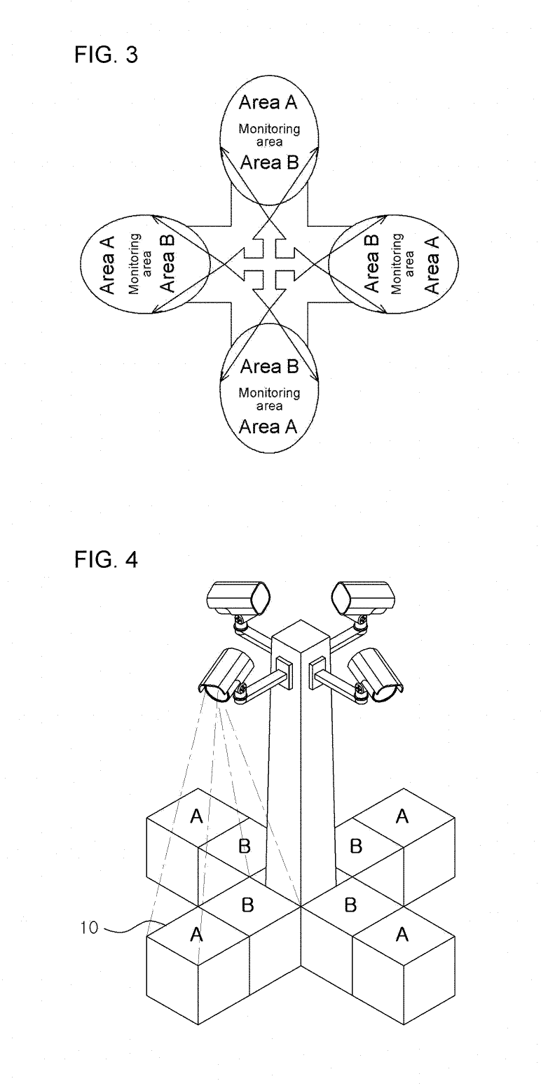

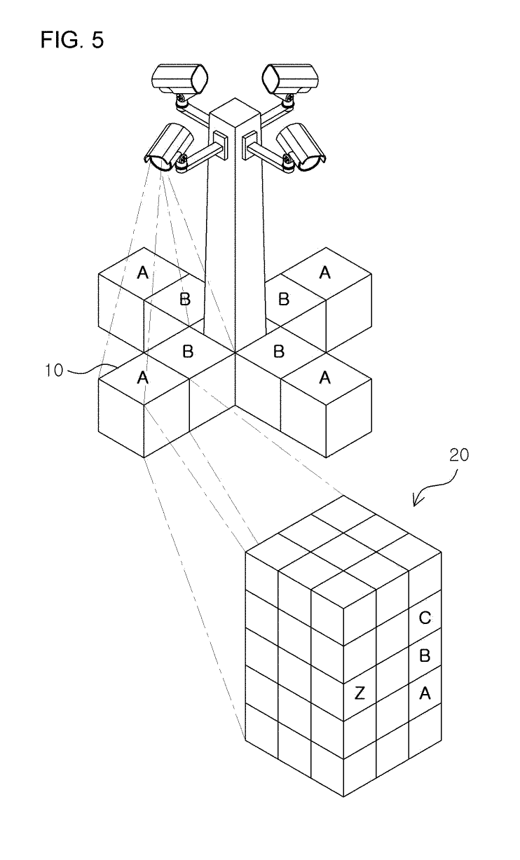

FIG. 3 is a plan view of the photographing areas of stereo cameras included in an embodiment of the present invention, FIG. 4 is a diagram showing the photographing areas of FIG. 3 in the form of a 3-D depth map, and FIG. 5 is a diagram showing the 3-D space map in which the plurality of depth maps shown n FIG. 4 has been matched into one.

In FIG. 3, arrows in the directions indicate the photographing directions of the first to fourth stereo cameras 110. As shown in FIG. 3, an image captured by each of the stereo cameras 110, that is, a monitoring area, is divided into an area B at a distance close to the stereo camera 110 to an area A distant from the stereo camera 110. The area A and the area B are converted into a 3-D depth map 10 according to a parallax value between the left-eye lens and right-eye lens of the stereo camera 110, as show in FIG. 4.

Furthermore, the area A depth map 10 and area B depth map 13 of each of the first to fourth stereo cameras 110 are match up into a space map 20 of a 3-D digital form by the space data composition unit 120, as shown in FIG. 5. That is, although not shown in the drawing, colors and coordinate data inputted by the photographing of the stereo cameras 110 are match with specific locations of the space map 20. Accordingly, in the space map 20, point clouds, that is, the many colors and coordinate data of the first to fourth stereo cameras 110, gather to form a spatial configuration.

The subject sensing unit 130 analyzes the point clouds of the space map 20. If, as a result of the analysis there is a change in a specific point, the subject sensing unit 130 detects that the subject is present in a photographing area of a stereo camera 110 that corresponds to the corresponding specific point. In this case, the space map 20 is stored in the form of a data structure having the same form within the same memory. A change in the point in any one area is generally shared, and thus the subject can be continuously tracked when it moves.

The PTZ camera 150 performing panning and tilting so that a photographing direction is directed toward the subject. The PTZ camera 150 performs zooming based on a person's face if the subject is a person and performs zooming based on a license plate if the subject is a vehicle. The PTZ camera 150 may have higher resolution than the stereo camera 110 for sensing a movement of the subject because it identifies information about the subject as described above. Furthermore, the PTZ camera 150 and the stereo cameras 110 are adjacently installed because the PTZ camera 150 has to cover all of photographing ranges of the stereo cameras 110. For example, the plurality of stereo camera 110 may be installed around the PTZ camera 150 in a form that surrounds the PTZ camera 150.

In this case, the PTZ camera 150 is controlled based on a driving value calculated by the driving control unit 140. The driving control unit 140 drives the PTZ camera 150 using any one of a first method and a second method or a combination of the first and the second methods as a method for driving the PTZ camera 150.

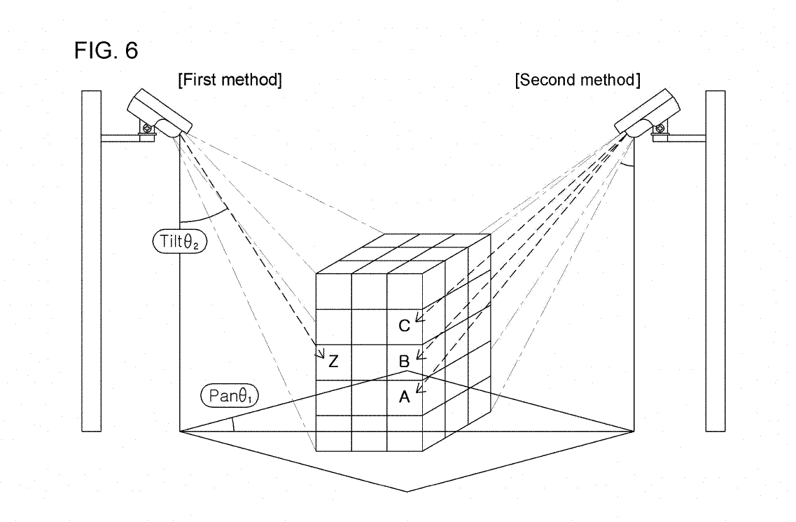

FIG. 6 is a diagram for illustrating a comparison between the driving of the PTZ camera 150 according to the first method and the driving of the PTZ camera 150 according to the second method.

Referring to FIG. 6, in the first method for controlling the PTZ camera 150, first, an initial value is set by matching the location of any one point in the photographing range of the stereo camera 110 with the angle of the PTZ camera 150. Thereafter, when the subject is sensed, a pan angle 81 and tilt angle 82 necessary for a movement are calculated based on the center coordinates (e.g., “Z” in FIG. 6) of the subject so that the PTZ camera 150 is directed toward the subject. The distance between the subject and the PTZ camera 150 is calculated, and a zoom level is adjusted. The above operation may be repeated until the subject disappears from the photographing range.

The first method is advantageous in that it can precisely capture the subject, but may generate system overload because data for operation is increased. For this reason, the second method y be used to supplement the first method.

In the second method for controlling the PTZ camera 150 first, the photographing zones of a 3-D space are set. The driving values of the PTZ camera 150 are manually preset so that the PTZ camera 150 is directed toward the set photographing zones (e.g. “A”, and “C” in FIG. 6). Thereafter, when the subject is sensed in the zone “A” the preset value of the zone “A” is fetched, and the PTZ camera 150 is driven so that it is directed toward the subject in the zone “A.” The same principle is applied to a case where the subject is sensed in the zone “B” or the zone “C.” Only the zones “A”, “B”, and “C” have been illustrated, for convenience of description, but the driving values of the PTZ camera 150 for all of zones, that is, the subject of photographing, may be preset.

The above detailed description illustrates the present invention. Furthermore, the aforementioned contents merely illustrate and describe a preferred embodiment of the present invention, arid the present invention may be used in various other combinations, changes and environments. That is, the present invention may be changed or modified within the scope of the concept of the invention disclosed in the specification an equivalent range of the aforementioned disclosure contents and/or the range of the technology or knowledge in the art. The aforementioned embodiments are for describing the best state in implementing the present invention, may be implemented in another state known to those skilled in the art in using the same invention as the present invention, and may be changed in various ways according to a detailed application field and use of the invention, Accordingly, the detailed description of the invention is a disclosed embodiment and s not intended to limit the present invention. Furthermore, the attached claims should be construed as including other embodiments.

### INDUSTRIAL APPLICABILITY

The present invention relates to a system for tracking the subject that moves within a space using a plurality of stereo cameras. The system can continuously track the subject although the subject moves while it is tracked, can extract the 3-D coordinates of the subject using the stereo cameras, can precisely track the subject by setting the pan, tilt, and zoom driving values of the PTZ camera, and can be used in CCTV installed for parking regulation in an underground parking lot or a road.

1. A system for tracking a subject that moves within a space using a plurality of stereo cameras, the system comprising:
a plurality of stereo cameras fixed and installed in different directions;
a space data composition unit configured to form a space map in which information about a 3-D space is shared by matching depth maps generated in photographing areas of the plurality of stereo cameras;
a subject sensing unit configured to analyze point clouds of the space map and to determine that a subject is present in a photographing area of a stereo camera corresponding to a specific point when there is a change in the specific point;
a PTZ camera configured to move so that a photographing direction is directed toward the subject by performing panning and tilting and to perform zooming based on the subject; and
a driving control unit configured to drive the PTZ camera using any one of a first method for setting an initial value by matching a location of any one point in a photographing range of a stereo camera with an angle of the PTZ camera and for driving the PTZ camera based on a zoom level calculated based on a pan angle and tilt angle for a movement based on center coordinates of a subject when the subject is sensed and a distance between the subject and the PTZ camera and a second method for setting photographing zones of the 3-D space, manually presetting driving values of the PTZ camera so that a photographing direction is directed toward a set photographing zone, fetching the preset value of the zone in which a subject is sensed, and driving the PTZ camera or a combination of the first and the second methods,
wherein four stereo cameras are installed to photograph east, west, south, and north directions respectively,
the four stereo cameras are spaced apart, from each other and each comprises a left-eye lens and a right-eye lens having parallel optical axes and
the four stereo cameras are installed around the PTZ camera in a form to surround the PTZ camera.
